(19) United States
(12) Patent Application Publication
(10) Pub. No.: US 2023/0375134 A1
(43) Pub. Date: Nov. 23, 2023

(54) CRYOGENIC TANK SYSTEM

(71) Applicant: MAGNA Energy Storage Systems GesmbH, Sinabelkirchen (AT)

(72) Inventors: Rainer PUCHLEITNER, Graz (AT); Sergiy PUTSELYK, Pinkafeld (AT)

(21) Appl. No.: 18/318,383

(22) Filed: May 16, 2023

(30) Foreign Application Priority Data
May 17, 2022 (DE) 102022204884.9

(51) Int. Cl. F17C 1/12

(52) U.S. Cl. CPC F17C 1/12; F17C 2205/0332; F17C 2221/012; F17C 2227/0306; F17C 2227/0304; F17C 2223/0161; F17C 2250/043

(57) ABSTRACT

A cryotank system comprising a first cryotank device and a second cryotank device. The first cryotank device includes a first cryotank to hold hydrogen, an extraction line operable to feed a consumer, a pressure sensor operable to measure pressure in the first cryotank, a heating line into which a partial flow of the extraction line can be branched off at a first junction, a first heat exchanger arranged in the first cryotank, wherein the heating line extends through the first heat exchanger and returns into the extraction line after the first heat exchanger at a second junction, at least one switching element operable to activate or deactivate the first heat exchanger in response to a measured pressure by the pressure sensor, and a first filling line operable to facilitate filling of the first cryotank with hydrogen. The second cryotank device includes a second cryotank to hold hydrogen, and a second filling line operable to facilitate filling of the second cryotank with hydrogen. A connecting line is operable to fluidically connect the first filling line to the second filling line.

### CROSS-REFERENCE TO RELATED APPLICATIONS

The present application claims priority under 35 U.S.C. § 119 to German Patent Publication No. DE 102022204884.9 (filed on May 17, 2022), which is hereby incorporated by reference in its complete entirety.

### TECHNICAL FIELD

One or more embodiments of the present disclosure relates to a cryotank system comprising a first cryotank device and a second cryotank device, wherein the first cryotank device comprises a first cryotank and the second cryotank device comprises a second cryotank, in particular respectively to hold hydrogen.

### BACKGROUND

Cryotank systems that comprise a cryotank for holding hydrogen are known, and are used in particular as mobile cryotank systems, for example in motor vehicles. Each cryotank may comprise an inner container and an outer container, in which case an insulating vacuum space may be established between the inner container and the outer container.

Cryotank systems may also comprise a plurality of cryotanks, for example two cryotanks, for holding hydrogen. Each of the cryotanks must then also be capable of being filled, for which purpose a plurality of separate filling lines are conventionally provided.

In order to regulate the pressure in a cryotank, in particular during or after the extraction of hydrogen from the cryotank, pressure regulating devices may be provided, for example electrical heating in the cryotank or a recirculating line, through which extracted and warmed hydrogen is partially returned into the cryotank in order to raise the temperature and therefore the pressure in the cryotank.

### SUMMARY

One or more embodiments are to provide a cryotank system of the type mentioned, which comprises at least two cryotanks, the intention being to allow fueling on one side and simple operation of the system consisting of a plurality of cryogenic liquid-hydrogen tanks, in particular mobile cryogenic liquid-hydrogen tanks. Fueling via supercritical hydrogen and subcooled hydrogen is in this case also intended to be possible.

In accordance with one or more embodiments, a cryotank system comprises a first cryotank device having a first cryotank, and a second cryotank device having a second cryotank. The first cryotank and the second cryotank are operable to hold hydrogen. The first cryotank device has an extraction line for feeding a consumer and a pressure sensor for measuring the pressure in the first cryotank. A partial flow of the extraction line can be branched off at a first junction into a heating line. The heating line leads through a first heat exchanger arranged in the first cryotank and returns into the extraction line after the first heat exchanger at a second junction. The first cryotank device further includes at least one switching element which is operable in such a way that the first heat exchanger is activated or deactivated depending on the pressure measured in the first cryotank by the pressure sensor. The first cryotank can be filled via a first filling line and the second cryotank can be filled via a second filling line. A connecting line is operable to fluidically connect the first filling line to the second filling line.

In accordance with one or more embodiments, a cryotank system comprises two cryotank devices that includes a first cryotank device having a first cryotank and a second cryotank device having a second cryotank. The first cryotank device has a switching element with which, depending on the pressure measured in the first cryotank by a pressure sensor, a first heat exchanger in the first cryotank can be activated or deactivated so that the medium in the first cryotank can be warmed via the heat exchanger and the pressure in the first cryotank can therefore be controlled. The first heat exchanger in the first cryotank may preferably be activated or deactivated by the fluid flowing through the extraction line being branched off towards the first heat exchanger, for example partially or fully, or not, via the switching element. The first cryotank pressure-regulatable in this way is connected to the second cryotank by a connecting line being operable to fluidically connect the first filling line to the second filling line.

The cryotanks may in particular be intended to hold liquid, gaseous or supercritical hydrogen, and the extraction line may be operable to extract gaseous or supercritical hydrogen for feeding a consumer.

The present dual tank system may use two tank systems, preferably with substantially the same design, which are connected via a cryogenic connecting line. This preferentially vacuum-insulated connecting line allows transfer of cryogenic fluid from one cryotank into the other.

Shut-off valves in the filling lines and/or in the connecting line may in this case allow series or parallel fueling of both tanks.

The pressure regulation of the two tanks may be controlled either separately or from one tank, for example from the first cryotank.

The present invention therefore allows fueling of a plurality of cryogenic tanks of a mobile cryogenic tank system for hydrogen storage from one side, from one filling connection, and allows not only fueling via two-phase or multi-phase hydrogen mixtures but also fueling via supercritical hydrogen and subcooled hydrogen, as well as simple operation of the multi-tank system.

In accordance with one or more embodiments, a second heat exchanger is arranged on the extraction line between the first cryotank and the first junction, the second heat exchanger preferably being warmed by a warm fluid, for example by water or a G40 (GLYSANTIN G40) mixture.

In accordance with one or more embodiments, a third heat exchanger is arranged on the heating line between the first heat exchanger and the second junction, i.e., downstream of the first heat exchanger. The third heat exchanger is operable to be warmed by a warm fluid, for example, by water or a G40 mixture. The switching element branches off a part of the hydrogen flow after the second heat exchanger towards the first heat exchanger, where the warm hydrogen is cooled again. The cold hydrogen flow may subsequently be warmed to ambient temperature in the third heat exchanger and, for example, fed back to the remaining part of the hydrogen flow.

In accordance with one or more embodiments, a valve, preferably a switching valve, is provided on the filling line, preferably on each filling line, particularly after the junction of the connecting line and before the first cryotank. Alternatively or in addition, one or two valves, in particular switching valves, may be provided on the connecting line. The pressure regulation of the two tanks may therefore be controlled either separately, when both switching valves are closed, or from one tank, for example, from the first cryotank device, when both valves are open.

As used herein, the term “valve” means a switching valve in the context of this disclosure. By a valve, a throughput may be at least blocked or, depending on the design, also reduced.

In accordance with one or more embodiments, the first heat exchanger is formed by a tube, the tube preferably having inner and/or outer fins.

In accordance with one or more embodiments, the first cryotank is arranged together with the first heat exchanger and preferably also with the second heat exchanger in the interior of a thermally insulating housing, at least the extraction line being fed outwards by passing through the housing. The switching element may be arranged outside the housing or inside the housing. The interior of the housing may furthermore contain valves or hydrodynamic impedances. The second heat exchanger may also be arranged outside the housing.

In accordance with one or more embodiments, the third heat exchanger is arranged outside the housing. It may also be arranged inside the housing. The pressure sensor is preferably likewise arranged outside the housing, or is arranged inside the housing.

In accordance with one or more embodiments, the housing has a filling connection and a venting connection, the filling connection being connected to the filling line and the venting connection being connected to a venting line.

In accordance with one or more embodiments, at least one of the extraction line, the filling line, and the venting line (e.g., the extraction line and the venting line) is provided with at least an overpressure relief which passes through the housing.

In accordance with one or more embodiments, the first cryotank device comprises an electrical heater that is thermally linked to the first cryotank and arranged between the first cryotank and the housing.

The switching element of the first cryotank device may fulfill two functions, namely distribution of the main flow from the first cryotank via the extraction line into flows on the one hand to the pressure regulating system via the heating line and on the other hand of the remaining flow to the consumer further via the extraction line, as well as the generation of pressure losses in the extraction line so that the pressure losses in the pressurization system, i.e., in the heating line and in the first and third heat exchangers are compensated for.

The switching element may preferably be formed by a 3/2-way valve, which has an integrated pressure loss element and is arranged at the first junction or second junction. Preferentially, the 3/2-way valve is therefore arranged before the first heat exchanger or optionally after the third heat exchanger.

In accordance with one embodiment, the switching element comprises two valves, namely one valve at the entry to the pressure regulating system in the heating line and the other valve in the main flow in the extraction line, or the switching element comprises two valves, namely one valve at the exit of the pressure regulating system in the heating line and the other valve in the main flow in the heating line.

In accordance with another embodiment, the switching element comprises a valve at the entry of the pressure regulating system in the heating line, i.e., at the entry of the heating line after the first junction, and a hydrodynamic impedance, for example, a diaphragm, in the main flow of the extraction line, or a valve at the exit of the pressure regulating system in the heating line, i.e., at the exit of the heating line before the second junction, and a hydrodynamic impedance, for example, a diaphragm, in the main flow of the extraction line.

In accordance with one or more embodiments, the switching element comprises a valve in the main flow of the extraction line and a hydrodynamic impedance, for example a diaphragm, at the entry of the pressure regulating system in the heating line, i.e., at the entry of the heating line after the first junction, or a valve in the main flow of the extraction line and a hydrodynamic impedance, for example a diaphragm, at the exit of the pressure regulating system in the heating line, i.e., at the exit of the heating line before the second junction, or the switching element is formed only by a valve in the main flow of the extraction line.

In accordance with one or more embodiments, the second cryotank device is configured with substantially the same design as the first cryotank device, i.e., it has the same components described above as the first cryotank device. In particular, the second cryotank device may likewise have a pressure regulating system as described for the first cryotank device. A venting line may in this case also be provided only on one of the two cryotank devices, for example on the first cryotank device. The gas may therefore, when necessary, be discharged from only one side.

In accordance with one or more embodiments, the pressure sensor is attached to the extraction line.

In accordance with one or more embodiments, a valve is arranged in the venting line. In this case, the venting connection may be configured straightforwardly, for example with a seal for hydrogen gas.

### DRAWINGS

One or more embodiments will be illustrated by way of example in the drawings and explained in the description hereinbelow.

FIG. 1 is a schematic representation of a cryotank system, in accordance with one or more embodiments.

FIG. 2 is a schematic representation which shows a pressure regulating system on the heating line of the cryotank system of FIG. 1, in in accordance with a first embodiment.

FIG. 3 is a schematic representation which shows the pressure regulating system on the heating line of the cryotank system of FIG. 1, in accordance with a second embodiment.

FIG. 4 is a schematic representation which shows the pressure regulating system on the heating line of the cryotank system of FIG. 1 in accordance with a third embodiment.

FIG. 5 is a schematic representation which shows the pressure regulating system on the heating line of the cryotank system of FIG. 1 in accordance with a fourth embodiment.

FIG. 6 is a schematic representation which shows the pressure regulating system on the heating line of the cryotank system of FIG. 1 in accordance with a fifth embodiment.

FIG. 7 is a schematic representation which shows the pressure regulating system on the heating line of the cryotank system of FIG. 1 in accordance with a sixth embodiment.

FIG. 8 is a schematic representation which shows the pressure regulating system on the heating line of the cryotank system of FIG. 1 in accordance with a seventh embodiment.

### DESCRIPTION

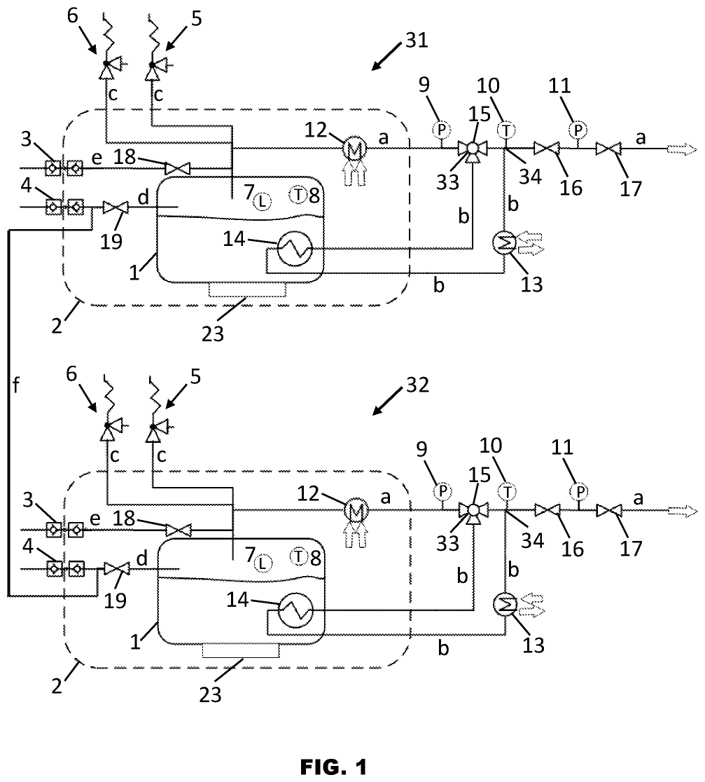

FIG. 1 represents a cryotank system in accordance with one or more embodiments. The cryotank system comprises a first cryotank device 31 and a second cryotank device 32, the first cryotank device 31 comprising a first cryotank 1 and the second cryotank device 32 comprising a second cryotank 1, in particular respectively to hold hydrogen.

The second cryotank device 32 is in this case configured with substantially the same design as the first cryotank device 31, i.e., it has the same components as the first cryotank device 31. Although the following description of the components relates to the first cryotank device 31, it therefore also applies for the second cryotank device 32.

The first cryotank 1 can be filled via a first filling line d and the second cryotank 1 can be filled via a second filling line d. A connecting line f is operable to fluidically connect the first filling line d to the second filling line d.

A valve 19 is provided on the filling lined, after the junction of the connecting line f and before the first cryotank 1. When the valve 19 is closed, the medium supplied to the filling line d only reaches the connecting line f and therefore the other cryotank 1, or enters into the other cryotank 1 if its valve 19 is not closed.

The first cryotank device 31 comprises an extraction line a for feeding a consumer (at the right-hand end of the extraction line a, indicated in FIG. 1 by an arrow towards the right). A pressure sensor 9 is arranged on the extraction line a in order to measure the pressure in the first cryotank 1.

At a first junction 33, a partial flow of the extraction line a can be branched off into a heating line b. The heating line b leads through a first heat exchanger 14 arranged in the first cryotank 1 and, after this first heat exchanger 14, back into the extraction line a at a second junction 34.

The first cryotank device 31 comprises at least one switching element 15, which is adapted in such a way that the first heat exchanger 14 is activated or deactivated depending on the pressure in the first cryotank 1 measured by the pressure sensor 9, the activation and deactivation of the heat exchanger 14 being carried out by at least one partial flow from the extraction line a being conveyed or not conveyed into the heating line b, and therefore to the heat exchanger 14, via the switching element 15.

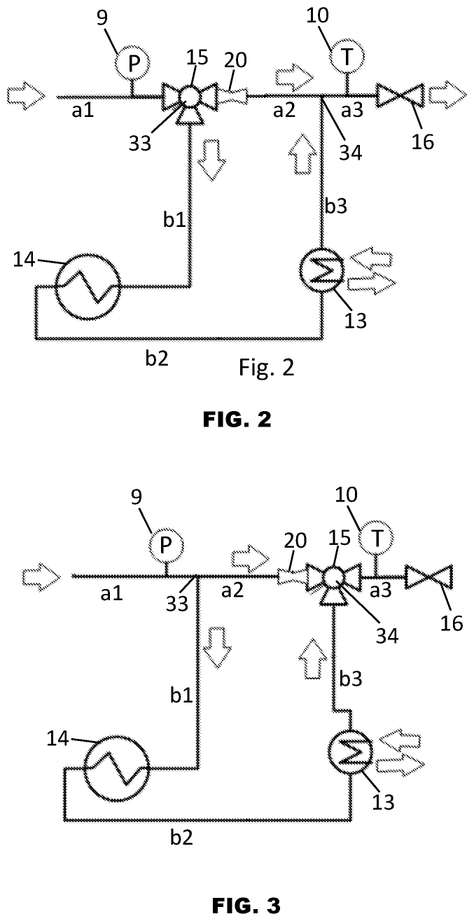

The return of the medium from the extraction line a via the heating line b with the heat exchanger 14 via the switching element 15 forms a pressure regulating system. Several variants of the switching element 15, and therefore of pressure regulating systems, are represented in FIGS. 2 to 8.

The first heat exchanger 14 is formed by a tube, in which case the tube may have inner and/or outer fins.

A second heat exchanger 12 is arranged on the extraction line a between the first cryotank 1 and the first junction 33, the second heat exchanger 12 being warmed by a warm fluid, for example, by water or a G40 mixture.

A third heat exchanger 13 is arranged on the heating line b between the first heat exchanger 14 and the second junction 34, the third heat exchanger 13 being warmed by a warm fluid, for example by water or a G40 mixture.

The first cryotank 1 is arranged together with the first heat exchanger 14 and with the second heat exchanger 12 in the interior of a thermally insulating housing 2. The extraction line a is fed outwards through the housing 2. The housing 2 has a filling connection 4 and a venting connection 3, the filling connection 4 being connected to the filling line d and the venting connection 3 being connected to a venting line e. A valve 18 is arranged in the venting line e. The switching element 15, the third heat exchanger 13 and the pressure sensor 9 are arranged outside the housing 2. A valve 18 is arranged in the venting line e.

Besides the pressure sensor 9, a further pressure sensor 11 and a temperature sensor 10 are arranged on the extraction line a. The temperature sensor 10 is arranged after the switching element 15 and before the valve 16, while the further pressure sensor 11 is arranged after the valve 16 and a further valve 17 on the extraction line a. After the valve 17, the extraction line a leads to a consumer connection and/or to a consumer.

A filling level sensor 7 and a temperature sensor 8 are furthermore arranged in the first cryotank 1.

The first cryotank device 31 also comprises an electrical heater 22, the electrical heater 22 being thermally linked to the first cryotank 1 and being arranged between the first cryotank 1 and the housing 2, inside the housing 2.

The extraction line a and the venting line e are each arranged with an overpressure relief 5, 6 which passes through the housing 2, via overpressure lines c.

FIG. 2 shows the pressure regulating system on the heating line of a cryotank system according to FIG. 1 in a first embodiment. The switching element 15 is configured as a 3/2-way valve with an integrated pressure loss element 20 and is arranged at the first junction 33. In the embodiment of FIG. 3, the 3/2-way valve is arranged at the second junction 34.

For the extraction line a, FIGS. 2 to 8 represent a division into a first section a1 as far as the first junction 33, a second section a2 between the first junction 33 and the second junction 34, and a third section a3 after the second junction 34. For the heating line b, FIGS. 2 to 8 represent a division into a first section 131 from the first junction 33 to the first heat exchanger 14, a second section b2 from the first heat exchanger 14 to the third heat exchanger 13, and a third section b3 after the third heat exchanger 13 as far as the second junction 34.

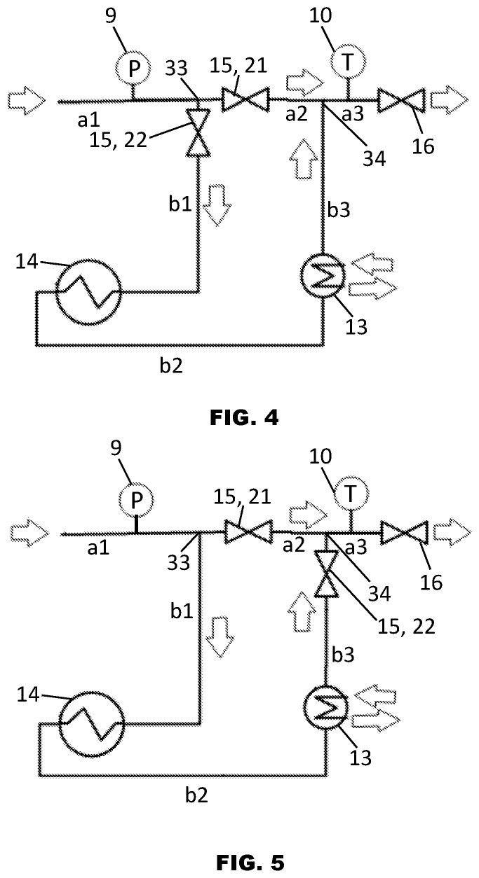

FIG. 4 shows an embodiment in which the switching element 15 comprises two valves 21, 22, namely one valve 22 at the entry to the pressure regulating system in the heating line 131 and the other valve, 21, in the main flow in the extraction line a2, namely in the second section of the extraction line a2, which lies between the two junctions 33, 34.

Similarly, in FIG. 5 the valve 22 is arranged at the exit of the pressure regulating system in the heating line b3 and the other valve, 21, is arranged in the main flow in the extraction line a2.

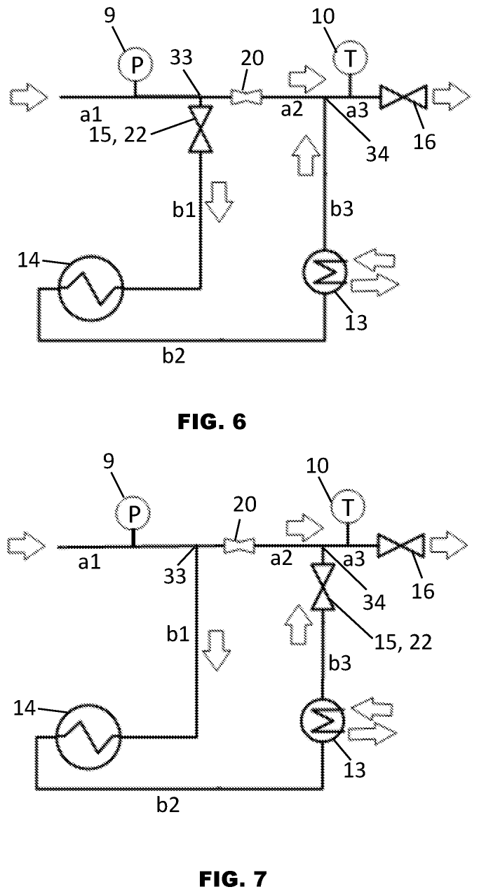

FIG. 6 shows an embodiment in which the switching element 15 is a valve 22 at the entry of the pressure regulating system in the heating line b1 and a hydrodynamic impedance 20, for example a diaphragm, in the main flow of the extraction line a2.

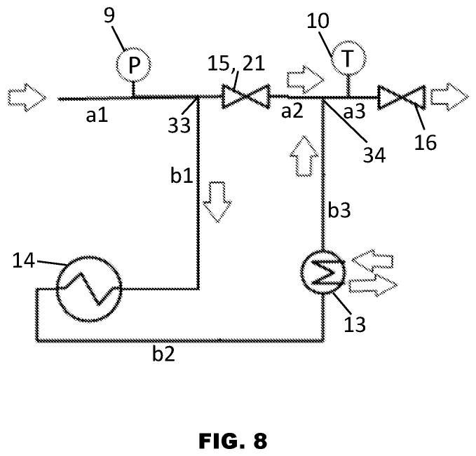

In FIG. 7, a valve 22 is arranged at the exit of the pressure regulating system in the heating line b3 and a hydrodynamic impedance 20, for example a diaphragm, is arranged in the main flow of the extraction line a2.

In another embodiment, which is not represented here, the switching element 15 is a valve 22 in the main flow of the extraction line a2 and a hydrodynamic impedance 20, for example a diaphragm, is arranged at the entry of the pressure regulating system in the heating line b1. Alternatively, a valve 22 may also be arranged in the main flow of the extraction line a2 and a hydrodynamic impedance 20, for example a diaphragm, may be arranged at the exit of the pressure regulating system in the heating line b3.

Lastly, FIG. 8 shows another embodiment in which the switching element 15 is formed only by a valve 21 in the main flow of the extraction line a2.

The terms “coupled,” “attached,” or “connected” may be used herein to refer to any type of relationship, direct or indirect, between the components in question, and may apply to electrical, mechanical, fluid, optical, electromagnetic, electromechanical, or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 cryotank
2 housing
3 venting connection
4 filling connection
overpressure relief
6 overpressure relief
7 filling level sensor
8 temperature sensor
9 pressure sensor
temperature sensor
11 further pressure sensor
12 second heat exchanger
13 third heat exchanger
14 first heat exchanger
switching element
16 valve
17 valve
18 valve
19 valve
pressure loss element
21 valve
22 valve
23 heater
31 first cryotank device
32 second cryotank device
33 first junction
34 second junction
a extraction line
a1 extraction line, first section
a2 extraction line, second section
a3 extraction line, third section
b heating line
b1 heating line, first section
b2 heating line, second section
b3 heating line, third section
c overpressure line
d filling line
e venting line
f connecting line

What is claimed is:

1. A cryotank system, comprising:
a first cryotank device that includes:
a first cryotank to hold hydrogen,
an extraction line operable to feed a consumer,
a pressure sensor operable to measure pressure in the first cryotank,
a heating line into which a partial flow of the extraction line can be branched off at a first junction,
a first heat exchanger arranged in the first cryotank, wherein the heating line extends through the first heat exchanger and returns into the extraction line after the first heat exchanger at a second junction,
at least one switching element operable to activate or deactivate the first heat exchanger in response to a measured pressure by the pressure sensor, and
a first filling line operable to facilitate filling of the first cryotank with hydrogen;
a second cryotank device that includes a second cryotank to hold hydrogen, and a second filling line operable to facilitate filling of the second cryotank with hydrogen; and
a connecting line operable to fluidically connect the first filling line to the second filling line.

2. The cryotank system of claim 1, further comprising a second heat exchanger arranged on the extraction line between the first cryotank and the first junction.

3. The cryotank system of claim 2, further comprising a third heat exchanger arranged on the heating line between the first heat exchanger and the second junction.

4. The cryotank system of claim 3, further comprising a thermally insulating housing having an interior into which the first cryotank, the first heat exchanger, and the second heat exchanger are arranged.

5. The cryotank system of claim 4, wherein:
at least the extraction line is fed outwards by passing through the thermally insulating housing, and
the switching element is arranged outside of the thermally insulating housing.

6. The cryotank system of claim 4, wherein:
the third heat exchanger is arranged outside of the thermally insulating housing, and
the pressure sensor is arranged outside of the thermally insulating housing.

7. The cryotank system of claim 4, wherein the thermally insulating housing has a filling connection fluidically connected to the filling line, and a venting connection fluidically connected to a venting line.

8. The cryotank system of claim 4, wherein at least one of the extraction line, the filling line, and the venting line is provided with an overpressure relief which extends through the thermally insulating housing.

9. The cryotank system of claim 4, wherein the first cryotank device further includes an electrical heater thermally connected to the first cryotank and arranged between the first cryotank and the thermally insulating housing.

10. The cryotank system of claim 1, further comprising a valve arranged on the first filling line upstream of the first cryotank after a junction of the connecting line.

11. The cryotank system of claim 1, further comprising two valves arranged on the connecting line.

12. The cryotank system of claim 1, wherein the first heat exchanger comprises a tube having inner and/or outer fins.

13. The cryotank system of claim 1, wherein the at least one switching element comprises a 3/2-way valve arranged at the first junction or at the second junction, the 3/2-way valve having an integrated pressure loss element.

14. The cryotank system of claim 1, wherein the at least one switching element comprises:
a first valve arranged at an entry to a pressure regulating system in the heating line, and
a second valve arranged in a main flow of the extraction line.

15. The cryotank system of claim 1, wherein the at least one switching element comprises:
a first valve arranged at an exit of a pressure regulating system in the heating line, and
a second valve arranged in a main flow of the extraction line.

16. The cryotank system of claim 1, wherein the switching element comprises:
a valve arranged at an entry to a pressure regulating system in the heating line, and
a hydrodynamic impedance arranged in a main flow of the extraction line.

17. The cryotank system of claim 1, wherein the switching element comprises:
a valve arranged at an exit of a pressure regulating system in the heating line, and
a hydrodynamic impedance arranged in a main flow of the extraction line.

18. The cryotank system of claim 1, wherein the switching element comprises:
a valve arranged in the main flow of the extraction line, and
a hydrodynamic impedance arranged at an entry of a pressure regulating system in the heating line.

19. The cryotank system of claim 1, wherein the switching element comprises a valve arranged in a main flow of the extraction line.

20. A cryotank system, comprising:
a first cryotank device and a second cryotank device, the first cryotank device and the second cryotank device respectively including:
a cryotank to hold hydrogen,
an extraction line operable to feed a consumer,
a pressure sensor operable to measure pressure in the first cryotank,
a heating line into which a partial flow of the extraction line can be branched off at a first junction,
a first heat exchanger arranged in the first cryotank, wherein the heating line extends through the first heat exchanger and returns into the extraction line after the first heat exchanger at a second junction,
at least one switching element operable to activate or deactivate the first heat exchanger in response to a measured pressure by the pressure sensor, and
a filling line operable to facilitate filling of the cryotank with hydrogen; and
a connecting line operable to fluidically connect the first cryotank device and the second cryotank device.
